(19) United States
(12) Patent Application Publication
(10) Pub. No.: US 2025/0220342 A1
(43) Pub. Date: Jul. 3, 2025

(54) Audio Apparatus Leveraging Microphone-Equipped Electronic Devices for Enhanced Audio Capture and Transmission, and Method of Producing Enhanced Audio Using Microphone-Equipped Devices

(71) Applicant: Skywalk Inc., Palo Alto, CA (US)

(72) Inventors: David Addison Harrison, West Chester, PA (US); Savannah Ashley Cofer, Lewis Center, OH (US); Tyler Nai Ming Chen, Carlsbad, CA (US)

(21) Appl. No.: 19/002,338

(22) Filed: Dec. 26, 2024

Related U.S. Application Data
(60) Provisional application No. 63/616,620, filed on Dec. 31, 2023.

(51) Int. Cl. H04R 3/00; H04R 1/02; H04R 1/10; H04R 1/40

(52) U.S. Cl. CPC H04R 3/005; H04R 1/028; H04R 1/1016; H04R 1/1041; H04R 1/406; H04R 2499/11

(57) ABSTRACT

Audio apparatus and methods of operating the same produce high-fidelity audio signals by leveraging discrete electronic devices each including a receiver, a microphone or microphone array, and a casing housing the receiver and the microphone or microphone array. The electronic devices are temporarily fixed to a stand in static positions as spaced apart from each. Sound from the ambient environment outside the stand is captured using the microphones or microphone arrays of the electronic devices and converted to respective streams of audio signals. The streams of audio signals are digitally processed by a processing unit, on board the stand, the electronic devices or an external device, of the apparatus based on information including distance between and orientations of the electronic devices in their static positions. The processed audio signals are transmitted digitally or as audio from one or more speakers.

### CROSS REFERENCE TO RELATED APPLICATIONS

The present utility patent application is related to and claims the benefit of priority of U.S. Provisional Patent Application No. 63/616,620 filed Dec. 31, 2023, entitled “Multi-microphone Device For Enhanced Audio Capture and Transmission”, and the entire contents of which are hereby incorporated by reference.

### BACKGROUND

The present technology relates to electronic devices that are equipped with microphones. In particular, the present technology relates to electronic devices equipped with microphones, receivers including those of transceivers and other electronic components such as transmitters and speakers, batteries, etc., so that sound captured by the microphones can be converted to digital audio signals and transmitted. The present technology also relates to noise canceling and distortion-preventing techniques used to enhance the fidelity of digital audio signals, and to related techniques such as voice canceling, speech-to-text and noisy-to-clear speech conversion. Thus, the present technology may be applied to speech recognition, beamforming, and conferencing including virtual conferencing, etc.

Speech recognition at its core is a technology aimed at capturing speech and reproducing an accurate version thereof. Speech recognition and similar applications present many challenges especially under certain conditions and in certain environments. Single microphone approaches typically suffer from drawbacks such as difficulty in distinguishing between multiple speakers and removing background noise, and can only output low fidelity audio signals. Existing attempts to solve these issues use multiple microphones in a fixed configuration, but these systems have limited feasibility because the fixed positions and orientations of the microphones is not optimal for many situations requiring their use.

### SUMMARY

An object of the present technology is to leverage microphone-equipped electronic devices to produce enhanced audio.

Similarly, another object of the present technology is to provide a method of producing enhanced audio by leveraging a plurality of microphone-equipped electronic devices.

According to one aspect of the present technology, there is provided audio apparatus for capturing ambient sound and producing an enhanced audio signal from the captured sound, comprising a plurality of discrete self-contained electronic devices each or collectively having an audio functionality apart from the apparatus, and a stand to which the electronic devices are held in respective static positions as spaced apart from each other and at which the microphone or microphone array of each of the electronic devices is acoustically exposed to the ambient environment. The discrete self-contained electronic devices each include a receiver, and a microphone or microphone array, and a casing housing the receiver and the microphone or microphone array. The stand includes means for temporarily holding the electronic devices in their respective static positions at which the microphone or microphone array of each of the electronic devices is acoustically exposed to the ambient environment. The audio apparatus also includes a processing unit operatively connected to the microphone or microphone array of each of the electronic devices so as to receive as input streams of audio signals from the microphones or microphone arrays of the electronic devices. The processing unit stores information indicative of the distance(s) between and orientations of the microphones or microphone arrays of the electronic devices in their respective static positions, and is configured to process the input streams of audio based on that information. The audio apparatus also includes a transmitter or at least one speaker operatively connected to the processing unit to transmit enhanced audio resulting from the processing of the signals using the information indicative of the distance between and orientations of the microphone or microphone arrays of the electronic devices.

According to another aspect of the present technology, there is provided audio apparatus for capturing ambient sound and producing an enhanced audio signal from the captured sound, comprising: a plurality of discrete microphone-equipped devices each having a microphone or microphone array housed in a casing wherein the devices each or collectively have an audio functionality apart from the apparatus, a stand discrete from the microphone-equipped devices, and a processing unit comprising a processor operatively connected to the microphone-equipped devices and non-transitory computer-readable media (CRM). The stand has means for temporarily holding the microphone-equipped devices in respective static positions at which the microphone or microphone array of each of the microphone-equipped devices is acoustically exposed to the ambient environment outside the stand. The non-transitory CRM stores operating instructions and information indicative of distance between and orientations of the microphone-equipped devices in their static positions. The processor is operatively connected to the microphone or microphone array of each of the electronic devices, and the processor is configured to: execute the operating instructions to control the microphone-equipped devices to capture raw audio and convert the raw audio to streams of audio signals, process the streams of audio signals based on the information indicative of the distance between and orientations of the microphone-equipped devices, and transmit a result of the processed streams of audio signals.

According to still another aspect of the present technology, there is provided a method of producing enhanced audio by leveraging electronic devices each including a receiver, a microphone or microphone array, and a casing housing the receiver and a microphone or microphone array, the method comprising: taking the electronic devices and temporarily fixing them to a stand in static positions as spaced apart from each, capturing sound from the ambient environment outside the stand using the microphones or microphone arrays of the electronic devices while in said static positions, and converting the sounds to respective streams of audio signals, digitally processing the streams of audio signals based on information including distance between and orientations of the electronic devices in said static positions, and transmitting the digitally processed audio signals.

### BRIEF DESCRIPTION OF THE DRAWINGS

These and other objects, features and advantages of the present technology will be better understood from the detailed description of preferred embodiments and examples thereof that follows with reference to the accompanying drawings, in which:

FIG. 1 is a flow chart of a method of capturing audio and transmitting an enhanced version of the audio;

FIG. 2A is a perspective view of one example of audio apparatus according to the present technology;

FIG. 2B is a perspective view of the stand of the apparatus of FIG. 2A in its open position;

FIG. 3A is a perspective view of a stand of another embodiment of audio apparatus according to the present technology;

FIG. 3B is a perspective view of the audio apparatus constituted by the stand of FIG. 3A, according to the present technology;

FIG. 4 is a user workflow diagram illustrating basic protocols of audio apparatus according to the present technology;

FIG. 5 is a schematic diagram of one example of audio apparatus according to the present technology, corresponding to the embodiment of FIGS. 2A and 2B; and

FIG. 6 is a schematic diagram of another example of audio apparatus according to the present technology, corresponding to the embodiment of FIGS. 3A and 3B.

### DETAILED DESCRIPTION

Embodiments of the present technology and examples thereof will now be described more fully in detail hereinafter with reference to the accompanying drawings. In the drawings, elements may be shown schematically for ease of understanding. Also, like numerals are used to designate like elements throughout the drawings.

Certain examples may be described and illustrated in terms of blocks which carry out a described function or functions. These blocks, which may be referred to herein as modules or the like, are physically implemented by analog and/or digital circuits such as logic gates, integrated circuits, microprocessors, microcontrollers, memory circuits, passive electronic components, active electronic components, optical components, hardwired circuits and the like, and may be driven by firmware and/or software of non-transitory computer readable media (CRM). In the present disclosure, the term non-transitory computer readable medium or media (CRM) refers to any medium that stores data in a machine-readable format for short periods or in the presence of power such as a memory device or Random Access Memory (RAM). The circuits may, for example, be embodied in one or more semiconductor chips, or on substrate supports such as printed circuit boards and the like. The circuits constituting a block may be implemented by dedicated hardware or by a specialized computer (e.g., one or more programmed microprocessors and associated circuitry, a CPU and/or a GPU, and associated memory programmed with and/or storing algorithms, operating instructions, audio signals/information, text, etc.), or by a combination of dedicated hardware to perform some functions of the block and a specialized computer to perform other functions of the block. Each block of the examples may be physically separated into two or more interacting and discrete blocks and conversely, the blocks of the examples may be physically combined into more complex blocks while still providing the essential functions of the present technology.

In addition, the terminology used herein for the purpose of describing embodiments of the present technology is to be taken in context. For example, the term “comprises” or “comprising” when used in this disclosure indicates the presence of stated features in a system or steps in a process but does not preclude the presence of additional features or steps. The term “sound” will be used in a broad sense to mean vibrations which can travel through air or another medium and which can be heard naturally or when amplified. Thus, the term “raw audio” may refer to sound from the ambient environment in which audio apparatus according to the present technology is situated (or through which the audio apparatus is traveling). The term “high-fidelity audio” will be used conventionally to refer to sound having inaudible noise and distortion to the human ear, as is well understood in the art. The term “contour” will be understood as referring to the shape of an outer portion in whole or in part of an element. The term “acoustically exposed” will refer to an element's exposure to an ambient environment to such a degree that the element can transmit or receive sound without that sound being distorted or muffled to an appreciable extent. Thus, acoustically exposed may be understood as not only open to but as including the presence of acoustically transparent material, such as speaker grill cloth, plastic, wire screen and mesh and open cell phone. Moreover, when the distance between microphones of respective electronic devices is referred to, such a description may refer to the distance between the centers of individual microphones of the respective electronic devices or the distance between the centers of microphone arrays of respective electronic devices.

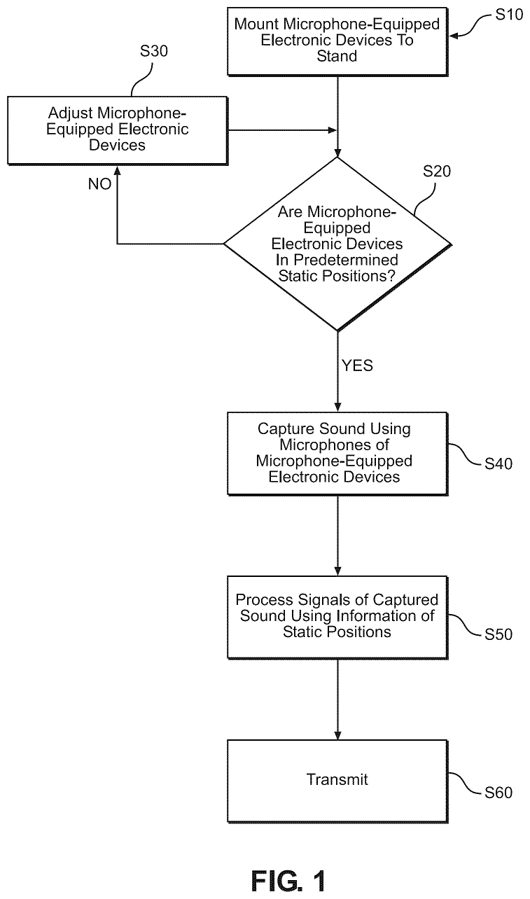

Referring now to FIG. 1, a method of producing enhanced, e.g., high-fidelity, audio for use in speech recognition or the like begins by mounting discrete self-contained microphone-equipped electronic devices to a stand as spaced apart from each other (S10), whereby the stand and microphone-equipped electronic devices together form an audio apparatus. Each of the microphone-equipped electronic devices, which may be referred to more simply as “electronic devices” or “microphone-equipped” devices, has at least one microphone (i.e., a single microphone, several microphones or a microphone array), a receiver, a speaker, and a casing, and may include various other components such as a battery, microprocessor, and transmitter, The microphone(s), receiver, speaker and other components are housed in the casing.

Examples of such microphone-equipped devices include ear-worn audio devices and mobile phones. Examples of ear-worn audio devices include True Wireless Stereo (TWS) earbuds, open-ear (OWS) earbuds, hearing aids, wired earbuds, i.e., basically any type of ear-worn audio device which can be used for audio recording and/or playback. In any case, the microphone-equipped devices will have an audio functionality (usefulness) apart from the stand, either individually as in the case of mobile phones or collectively as in the case of a pair of ear-worn audio devices.

The stand includes means for temporarily holding the microphone-equipped devices in respective and predetermined static positions at which the distance(s) between and orientations of the devices are specifications of the audio apparatus. The specifications can be predetermined or read from the microphone-equipped devices based on their model once they assume their static positions. For any microphone-equipped device, the structure of its microphone or microphone array is fixed and so, the distance(s) between and orientations of the devices corresponds to the distance(s) between and orientations of the respective devices. The stand and in particular, its holding means may be designed to optimize these specifications, e.g., maximize the distance between the microphones or microphone arrays in an array thereof when the microphone-equipped devices are in their static positions, or set a linear, circular, or planar geometry of the array depending on the desired functionality. In any case, these specifications of distance between and orientations of the microphone-equipped devices are optimized for leveraging the devices to capture sound in the ambient environment in which the audio apparatus is used and transmit enhanced (e.g., high-fidelity) audio of captured sound.

Examples of the means for holding the microphone-equipped devices in their static positions include portions of the stand defining cavities whose shapes are complementary to contours of the casings of the ear-worn audio devices, respectively. The microphone-equipped devices are received in the cavities in static positions under a high tolerance press-fit. Alternatively, the means for holding the microphone-equipped devices in their static positions may comprise ferromagnetic elements which attract ferromagnetic elements of the microphone-equipped devices to the stand.

A determination may be made as to whether the microphone-equipped devices are in the predetermined static positions relative to the stand (S20). For example, the stand may include proximity sensors integrated with certain other parts of the stand for sensing the presence of the microphone-equipped devices at their static positions, or for sensing whether part of the stand has been manipulated into a state in which the microphone-equipped devices must be in their static positions. Alternatively, the microphone-equipped devices may be equipped with proximity sensors triggered by the stand when they are in their static positions relative to the stand. The proximity sensors of the microphone-equipped devices may be similar to sensors of ear-worn audio devices, known per se, for detecting whether the ear-worn audio devices are situated in the ear canals of users. An example of proximity sensors that may be employed by the present technology are Hall Effect sensors.

In other examples, the sensors comprise electrical contacts and have a secondary function of connecting microcircuits of the microphone-equipped devices with circuitry in the stand. For example, the sensors are implemented as conductive spring-loaded pin contacts, and signals such as serial peripheral interface (SPI) signals are passed between the microphone-equipped devices and a processing unit in the stand. As another example, amplified microphone outputs from the microphone-equipped devices are connected directly to circuitry of the stand by an analog multiplexer. In addition, two or more microphone-equipped devices can be time-synchronized via a shared clock signal which is connected via electrical contact when the devices are in their static positions.

In any case, if the microphone-equipped devices are not in their static positions, the user can adjust them manually until they are (S30). In some examples, the means for holding the electronic devices ensures that the microphone-equipped devices are in their static positions and accordingly, step (S20) and step (S30) are omitted.

Once the microphone-equipped devices are in their respective static positions, they are powered on, charged, if necessary, and controlled to begin capturing sound in the ambient environment (S40). At this time, the audio signals produced by the microphones are processed based on the information of their relative positions and orientations (S50). Such information is representative of the specification of a microphone array constituted by the microphone-equipped devices, collectively. For example, the processing includes time-synchronizing the signals from the microphone(s) of the respective devices. Next, the processed signals are transmitted (S60), as enhanced by the signal processing (S50). Because the microphone-equipped devices are held in static positions at which their relative positions and orientations are known, the audio output by the microphones of the devices can be spatially and directionally controlled, i.e., so that the microphones can produce high-fidelity audio.

In addition, the present technology is well-suited to audio beamforming. Here, the microphone array may be controlled to selectively focus on sound coming from a specific direction, effectively “steering” a beam of sound towards a desired source of sound (e.g., a particular speaker) while minimizing noise from other directions by manipulating the timing and amplitude of signals received by the respective microphone(s) of the devices. The audio apparatus may thus act like a virtual microphone which captures sound from a targeted area. In other words, an algorithm tailored to the specifications and static positions of the microphone-equipped devices, and executed as part of the signal processing (S50), permits the creation of a virtual microphone(s) which can home in on or reject particular sources of sound. Accordingly, the audio apparatus of the present technology is useful for live or remote conferencing.

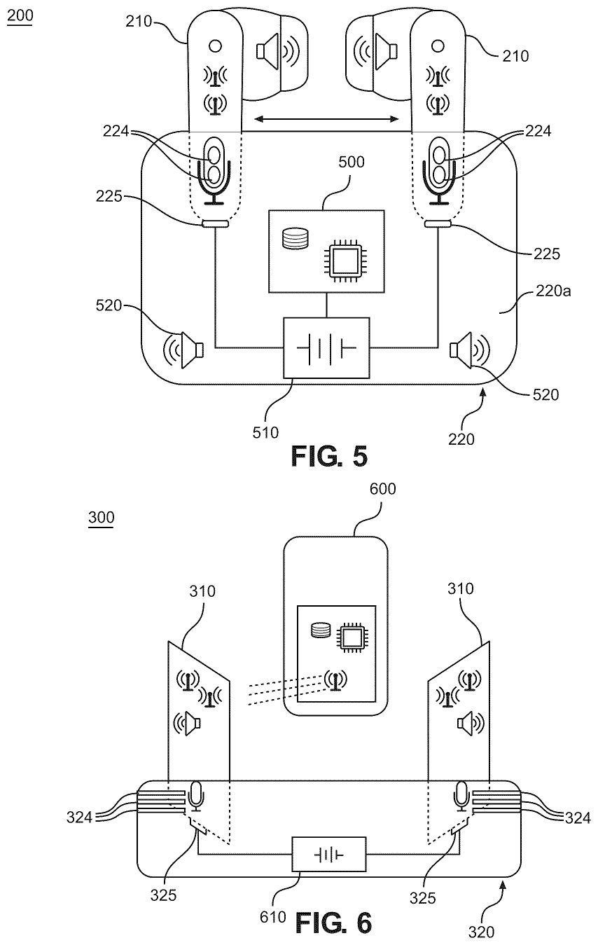

In some examples such as those shown in and described later with respect to FIGS. 5 and 6, the signal processing (S50) takes place in a processing unit of one or more of the microphone-equipped devices. In other examples, the signal processing (S50) takes place in a processing unit of the stand. Alternatively, raw signals of the audio captured by the microphones are transmitted to an external device having a processing unit, e.g., to a smart phone, desktop or laptop computer. The external device then processes the raw signals using the information of the distance(s) between and orientations of the microphones. Then, the processed signals, which have been enhanced by the signal processing (S50), are transmitted (S60) by the external device.

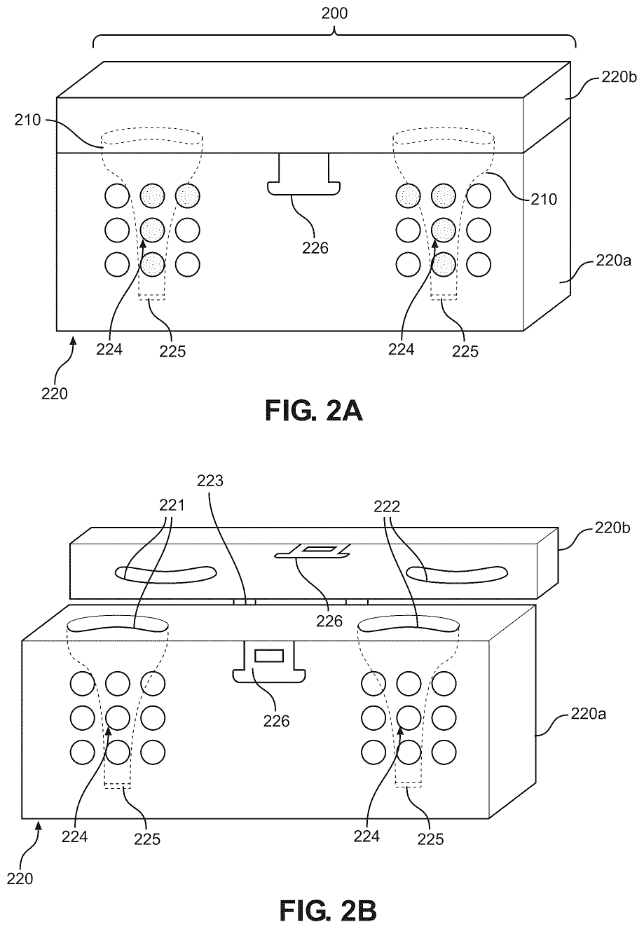

Referring now to FIGS. 2A and 2B, a first example of audio apparatus 200 for use in carrying out the method described above with respect to FIG. 1 includes a pair of ear-worn audio devices 210, and a stand in the form of a case 220 discrete from the ear-worn audio devices 210. The case 220 has cavities 221, 222 therein for temporarily holding the ear-worn audio devices 210 in respective static positions. To this end, the cavities 222 have shapes complementary to the contours of the casings of the ear-worn audio devices 210. That is, the cavities 222 have shapes corresponding to form factors of the ear-worn audio devices 210 so that the ear-worn audio devices 210 are press fit to the case 220 when received in the cavities 221, 222, respectively.

Furthermore, in this example, the case 220 has a base 220a and a cover 220b attached to the base 220a by a hinge 223 or the like so that the cover 220b is openable and closeable relative to the base 220a. Respective portions of each of the cavities 221, 222 are provided in the base 220a and cover 220b, respectively. However, the cavities 221, 222 may be provided entirely in the base 220a and the cover 220b may simply cap the ear-worn audio devices 210 when closed. In some examples the cover 220b is provided with an elastic element that presses against the ear-worn audio devices 210 and constitutes the means for holding the ear-worn audio devices 210 in their static positions.

The case 220 in the present example is of a hand-held type but may have various other shapes, configurations and compositions so long as the cavities 221, 222 hold the ear-worn audio devices 210 in static positions under a high tolerance press-fit with the microphones acoustically exposed to the ambient environment outside the case 220. To this end, the case 220 has acoustical channels 224 extending from an exterior surface thereof to the cavities 221, 222, respectively, and hence to the microphones of the ear-worn audio devices 210. The acoustical channels 224 acoustically expose or “couple” the microphones of the ear-worn audio devices 210 to the ambient environment outside the case 220. The acoustical channels 224 may be one or more openings (vents) in the case, as shown, and may additionally or alternatively be formed of acoustically transparent material that allows sound to pass easily therethrough in both directions. Examples of such acoustically transparent material include speaker grill cloth, some plastics, wire screen and mesh, open cell foam, and acoustically transparent fabrics, known per se. The case 220 may also have one or more elastic gaskets, e.g., an O-ring, extending around the acoustic channels 223, as interposed between the cavities 221, 222 and the exterior of the case to acoustically isolate a microphone(s)/microphone array with respect to the acoustic channel 224 associated therewith. Alternatively, the entirety of the case 220, or part of the case 220 that delimits the cavities 221, 222, may be made of acoustically transparent material such as the above-mentioned open cell foam. In this example, material of the case 220 serves as the acoustical channels 224.

The case 220 also includes sensors 225 operative to detect when the ear-worn audio devices 310 are in their respective static positions. In the illustrated example, the sensors are proximity sensors comprising metallic plates located within the cavities 221, 222 to confirm that the ear-worn audio devices 310 have been fully and correctly inserted into the cavities 221, 222. Alternatively or additionally, a proximity sensor may be disposed near the hinge 223 of the case 220 to check whether the cover 220b has been properly closed, because proper closure of the cover 220b can confirm that the ear-worn audio devices 210 are in their static positions owing to the small tolerances of the cavities 221, 223 with respect to the ear-worn audio devices 210. An example of a proximity sensor well-suited for checking whether the cover 220b has been properly closed is a magnetic proximity sensor. The case 220 may also have a closure 226 by which the cover 220b can be latched to the base 220a when closed. In some examples, the closure 226 is provided with a sensor that senses when it is in the closed position, and thereby confirms that the microphone-equipped devices have been fully and correctly inserted into the cavities 221, 222.

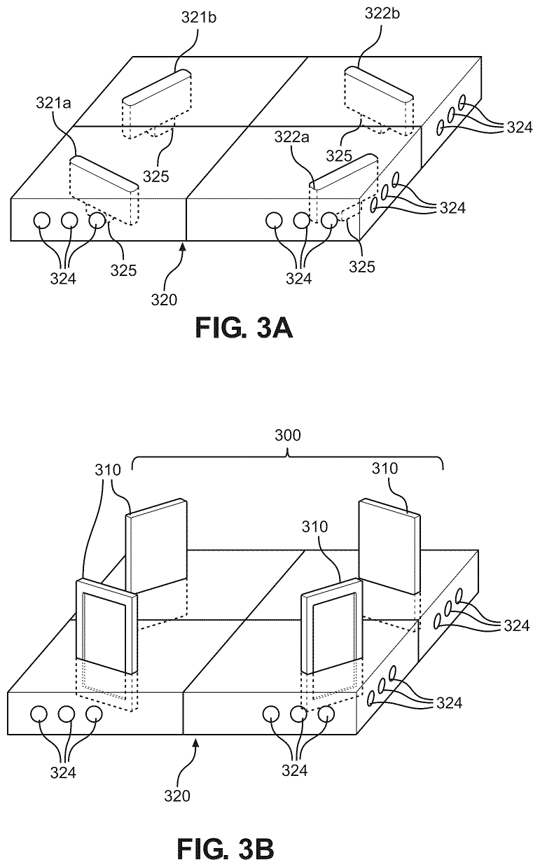

FIGS. 3A and 3B show an embodiment of audio apparatus 300 according to the present technology, for use with relatively large microphone-equipped devices, e.g., mobile electronic devices. The audio apparatus 300 of this embodiment includes mobile phones 310 and a foldable stand 320 that is a generally parallelepipedal platform when unfolded into the position shown in the figures. Hinges (not shown) between sections, e.g., quadrants, of the stand may allow the stand 310 to be folded up and unfolded, for example. The stand 320 has a plurality of cavities 321a, 321b, 322a, 322b that are oriented at different angles relative to a center line of the stand 320 and have shapes complementary to contours of the mobile phones 310. The mobile phones 310 are received in the of cavities 321a, 321b, 322a, 322b as press-fit to the stand 320 so as to be temporarily held in predetermined static positions. At these positions, the microphones of the mobile phones 310 collectively form a spatially-fixed microphone array in which the relative positions and orientations of the microphones of the respective mobile phones 310 are specifications of the audio apparatus 300. These specifications are used in processing the sound captured by the microphones.

In this example, the stand 320 has acoustical channels 324 extending from an exterior surface thereof to the cavities 321a, 321b, 322a, 322b, respectively, and hence to the microphones of the mobile phones 310 received in the cavities 321a, 321b, 322a, 322b. The acoustical channels 324 acoustically expose the microphones of the mobile phones 310 to the ambient environment outside the stand 420. The acoustical channels 324 may be realized similarly to the acoustical channels 224 described with respect to those of the case 220. Likewise, the stand 320 also includes sensors 325 operative to detect when the mobile phones 310 are in their respective static positions. In the illustrated example, the sensors are proximity sensors comprising metallic plates facing the cavities 321a, 321b, 322a, 322b to confirm that the mobile phones 310 have been fully and correctly inserted into the cavities 321a, 321b, 322a, 322b.

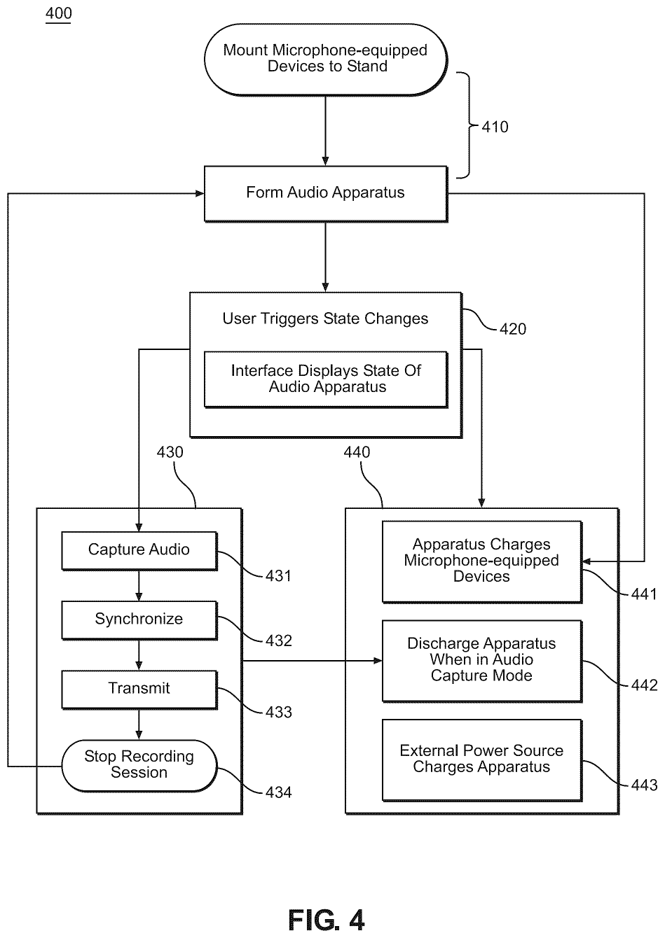

FIG. 4 illustrates an example of a process of using audio apparatus according to the present technology, i.e., a user workflow 400 as facilitated by an exemplary software module (processing unit and non-transitory computer readable media (CRM)) according to the present technology. The software module is responsible for notifying the user of the status of the audio apparatus and for establishing default user control, for controlling the capturing and processing of audio and the transmitting of the captured audio, and for power control of the audio apparatus. Thus, the software module provides a state machine protocol 420, an audio capture and transmission protocol 430 and a power control protocol 440 performed by a power control module.

Still referring to FIG. 4, the user workflow 400 begins with an apparatus set-up step 410 in which the user mounts the electronic devices to a customized stand to form the audio apparatus. For example, the user opens the cover 220b of case 220 (FIG. 2A), inserts ear-worn audio devices 210 into cavities 221, 222 (FIG. 2B), and closes the cover 220b or unfolds stand 320 (FIGS. 3A and 3B) and inserts mobile phones 310 into cavities 321a, 321b, 322a, 322b. Therefore, the set-up step may entail press-fitting, or alternatively magnetically attracting, microphone-equipped devices to a stand such that (1) a sensor of the stand detects the presence of the microphone-equipped devices in respective static positions, (2) the microphones of the microphone-equipped devices collectively constitute a microphone array, (3) the microphones of the array are acoustically exposed, e.g., coupled, to the ambient environment, and (4) the distance(s) between and relative orientations of the microphones of the array are optimal for audio capture, processing and transmission.

The state machine protocol 420, as set by operating instructions stored in non-transitory CRM of the software module, is responsible for facilitating the triggering and toggling between different operating states and the displaying the current state of the audio apparatus to the user on a user interface. The user interface allows the user to trigger changes between the different operating states and input various commands to the audio apparatus through conventional means, per se, such as buttons, icons on a touch screen, etc. The current state of the audio apparatus may include information about whether the apparatus is recording sound, information on the state of a battery/batteries of the stand/microphone-equipped devices and charging status of the same, and information of system errors.

The different operating states may include those found in True Wireless Stereo (TWS) earbuds, but with the addition of an “active listening” state for when the microphone-equipped devices are used as a beamformer to capture sound and produce high-fidelity audio. In particular, the states include those related to the external microphone-equipped devices such as whether the microphone(s) are being used to capture audio and analyze its spatial characteristics, states related to the audio apparatus itself such as whether the apparatus is transmitting the captured audio externally, and finally states that are related to power control. The state machine protocol 420 is also responsible for handling communication with other components of the audio apparatus such as a power control module for determining charging states, the user interface, and the sensor of the stand responsible for detecting when the microphone-equipped devices are in their predetermined static positions. The state machine protocol 420 also includes operating instructions for updating the current state of the audio apparatus in real time and may always display the state on the user interface.

More specifically, the user interface is preferably first used for signifying the current status and relevant system notifications of the audio apparatus, e.g., whether the apparatus is performing audio recording, its battery status, charging status, system notifications and system error. The apparatus status relates to the charging state of the stand or the microphone-equipped devices (i.e., whether the microphone-equipped devices are being charged, whether the stand of the apparatus is charging or plugged into an external power source, etc.), or the recording state of the apparatus (e.g., whether the apparatus is being currently used as a beamformer to record spatial/directional audio, whether the apparatus is currently transmitting recorded audio to other external devices, etc.). System errors can be battery-related (e.g., exceedingly low power level), hardware-related (e.g., disconnected circuitry, degraded circuitry), or software-related (e.g., error in capturing, processing, or transmitting audio).

The user interface can also take in user commands for executing actions such as changing the operating state from charging to record spatial and directional audio or transmitting captured audio or toggling between charging states of the microphone-equipped devices, e.g., setting the power consumption and usage of the microphone-equipped devices when recording to be more efficient or high-performing.

To any or all of these ends, the user interface, as provided by a mobile phone application, for example, may include a display such as a touch screen or monitor that displays the current state of the device to the user. The user can interact with the interface, retrieve additional information, toggle between operating states, and send commands by directly swiping and tapping on the screen to send commands or view additional information of the status of the audio apparatus.

The user interface may also or alternatively comprise tactile buttons and LED lights located at different positions on the stand. In some examples, a single button is dedicated to handle multiple commands when pressed in different patterns such as being held down for an extended period or being subjected to a quick press or double and multiple consecutive presses. In other examples, the user interface comprises multiple buttons with each button being dedicated for a subset of the potential user commands. For example, one button can be dedicated for all commands related to charging and another for toggling between audio recording states. The LED lights are used to signify the current state of the audio apparatus through their color or blinking patterns.

Another example of the user interface uses the audio modality of the apparatus for receiving auditory commands and notifying the user of the current operating state. In this example, the audio apparatus includes internal speakers located directly on the stand to voice out changes in the operating state and general system notifications, and a dedicated microphone(s) and processor for detecting and executing the audio commands spoken by the user. In some examples, the audio apparatus includes transmitters for forwarding the user's audio commands to external processors of a smart phone, laptop, desktop or the like or to (a server on) the cloud responsible for analyzing and processing and the audio signals. After analysis, apparatus-specific commands can be sent back to the audio apparatus to be executed accordingly. Some examples of this user interface include a tactile button or a set of tactile buttons that trigger the internal speaker to voice out the current state or most recent system notification of the apparatus when pressed by the user. Depending on the frequency and pattern at which the button(s) is/are pressed by the user (e.g., quickpress, double-press, holding down), the internal speakers can voice out different information related to the status of the audio apparatus.

The audio capture and transmission protocol 430 executable by a processing unit of the software module includes audio (sound) capture 431, synchronization 432, and enhanced audio transmission 433 protocols and a command for the audio apparatus to stop recording 434. In this example, the software module is configured with a beamforming algorithm based on specifications of the microphone array (characteristics of the microphone-equipped devices and the relative positions and orientations of their microphones in the audio apparatus), and transmission functionalities responsible for controlling the transmitting of outputs from the microphone-equipped devices. The beamforming algorithm as is known, per se, may apply digital filters to the inputted audio signals to in effect focus on sound in the ambient environment coming from one direction while attenuating sound coming from other directions.

Under the capture audio and synchronize protocols 431 and 432, streams of signals of raw audio captured from each of the microphone-equipped devices (210 or 310, for example) are input to the beamforming algorithm, the algorithm synchronizes the inputted signals, with respect to time, to prevent mismatch across the different microphones or sets of microphones, and finally the algorithm executes a beamforming computation on the synchronized signals to produce directional and spatial audio according to a methodology (filtering) known, per se. Under the transmit protocol 433, the audio enhanced as a result of the beamforming computation is transmitted to the cloud or to external devices such as a smart phone or laptop or desktop computer. The transmitting of the audio can also happen before the synchronization and beamforming; that is, the raw captured audio can be first transmitted to an external device or to the cloud and be later synchronized and processed to provide the enhanced audio. After transmission, the user then can trigger a stop recording session command 434. At this time, the microphone-equipped devices could be removed from the stand and returned to their original use(s) as ear-worn audio devices 210 or mobile phones 310, for example.

The power control protocol 440, as established by the power control module of the audio apparatus, will now be described in more detail. In examples of the audio apparatus according to the present technology such as in the audio apparatus 200 or 300 shown in and described with reference to FIGS. 2A and 2B and FIGS. 3A and 3B, the power control module preferably serves two primary functions. The first function is to handle communication and coordination with the software module to be power-efficient and regularly update its charging and discharging functionalities based on the current state of the apparatus and user commands. Depending on the current charging state determined by the state machine protocol, the power control module will be able to configure the device to charge the external microphone-equipped devices, discharge the external microphone-equipped devices in a power-efficient way when recording and transmitting audio, and discharge the external microphone-equipped devices to maximize performance or charge the apparatus. Additionally, the power control module ideally also provide power for both the stand and the microphone-equipped devices through a certain form of internal or external battery source or charging component.

In some examples, this component utilizes removable and commercial batteries for charging the apparatus. In some examples, the audio apparatus includes rechargeable or non-rechargeable battery slots in its stand. In examples like that shown in and described with reference to FIGS. 2A and 2B in which the stand is a case 220 that charged batteries are inserted into the battery slots, the power control module coordinates with the rest of the apparatus 200 to perform the battery- and power-related functionalities. In still another example, the power control module includes an internal battery that is not removable from the apparatus. This internal battery can be disposed within the stand or attached to the stand externally in a separate case. To charge the device, the user can do so either through wireless charging or some form of wired charging through ports such as a USB-C or Micro-USB port.

FIGS. 5 and 6 show embodiments of audio apparatus according to the present technology, including certain components thereof. In particular, the microphone-equipped devices, namely, the ear-worn audio devices 210 and mobile phones 310 are shown as having a wireless receiver, a speaker operatively connected to the wireless receiver so as to receive signals from the wireless receiver and convert the signals to sound, and at least one microphone, all disposed in their casings. Also, each of the embodiments are depicted as having a transmitter or speakers operatively connected to a processing unit to transmit audio or signals that have been processed based on said information indicative of the distance between and orientations of the microphones of the microphone-equipped devices. However, some components or parts, such as a conventional digital signal processor (DSP) operatively connected to the microphone(s) for processing signals from elements of the microphone(s), may be omitted for simplicity.

In one embodiment, e.g., in an example of audio apparatus 200 shown in FIG. 5, the entire processing unit 500 comprising the software module is located in the stand (bottom 220a of the case 220) of the audio apparatus. The beamforming algorithm, audio transmission functionalities, the state machine protocol, as well as the corresponding auxiliary microprocessors and custom circuitries are thus all disposed in the apparatus. Although the processing unit 500 is shown within the case 220, the processing unit 500 may instead be part of a separate component attached or wirelessly connected to the stand (e.g., case 220).

FIG. 5 also shows an example in which the case 220 also includes a battery 510, and speakers 520 which are used in transmitting audio that has been captured by microphones of the ear-worn audio devices 210 and processed by the processing unit 500. Also shown by the respective symbols in the figure are the microphones, receivers, speakers, etc. of the ear-worn audio devices 210, and the pairing thereof by the solid double-headed arrow. In this example, the ear-worn audio devices 210 are true wireless stereo earbuds (TWS) but, as was described above, could be of a wired type or other types of ear-worn audio devices.

In another embodiment of the audio apparatus, e.g., in an example of audio apparatus 300 shown in FIG. 6, some or all of the processing unit comprising the software module according to the present technology (configured with the beamforming algorithm), is provided by an external device 600 such as a phone or desktop computer and processed through a mobile or desktop application. In some examples, the part of the processing unit responsible for the audio transmission functionalities is provided in the stand 320 and used to transmit raw audio captured by the microphones of the microphone-equipped devices (e.g., mobile phones 310) to the external device 600, whereas the external device 600 has the part of the processing unit configured with the beamforming algorithm and components for synchronization of microphone signals. Accordingly, the transmitted raw audio inputs are processed into spatial and directional audio by the external device 600. The beamforming algorithm may be input to CRM of the processing unit of the external device 600 through mobile applications.

In still other examples, processing units of the microphone-equipped devices, e.g., the digital signal processor(s) of ear-worn audio devices 210 or the processing unit(s) of the mobile phones 310, are configured with the beamforming algorithm and components for synchronization of microphone signals. One of the processing units of the microphone-equipped devices may be configured with the processing units according to the present technology so as to serve as a master unit of the audio apparatus.

Audio apparatus according to the present technology may be provided with one or more of the following: (1) positioning and motion sensors, (2) audio-out devices such as internal speakers and audio-out ports, (3) on-device microprocessors for further processing the audio input after applying the beamforming algorithm, and (4) additional custom circuitries used for audio amplification or denoising. Examples of the positioning and motion sensors include an accelerometer(s), a gyroscope, a Global Positioning System (GPS) and an Inertial Measurement Unit (IMU) serving to facilitate the calculation and processing of the captured audio. The positioning and motion sensors can be integrated into the processing unit, user interface, and relevant circuitries to further enhance the accuracy and fidelity of the spatial and directional audio recording from the external microphone arrays. To this end the positioning and motion sensors impart a capability of using the additional real-time information provided by the sensors on global and relative positioning, acceleration as well as angular and rotation velocity around different axes (i.e., roll, pitch, yaw), For example, if the position and orientation of the device or the erratic movement of the device or the speaker are deemed by the sensors to be less than ideal or suitable for capturing spatial and directional audio, the device can leverage position and movement information to send out a system notification or status update to the user through the user interface and prompt the user to make appropriate adjustments if necessary (e.g., reorienting the device, stop moving the device, asking the speakers to move less erratically). In this respect, the position and motion sensors are especially useful when the audio apparatus is being carried or transported or implemented as a wearable device.

In some examples, multiple Inertial Measurement Units are provided for detecting the current orientation and position of the audio apparatus such as whether it is standing upright or lying flat on one of its sides. Using this information, the audio apparatus can subsequently modify and adapt the employed beamforming algorithm to ensure the quality of the captured directional and spatial audio. In situations where the inferred position and orientation of the device is judged to be unfit for optimal spatial and directional audio capture, if the microphone array is positioned relatively far from or collinear with the different speakers in an audio recording setting, the apparatus can send out a notification to the user and a request to move and adjust the orientation or positioning of the apparatus before proceeding with audio capturing.

In some examples, the audio apparatus includes an accelerometer or a series of accelerometers so that if the movement (i.e., acceleration and velocity) of the audio apparatus is deemed to be too fast, i.e., exceeding a given threshold, the processing unit utilizes this information to prompt the user to retard the movement of the apparatus. Using an accelerometer, the processing unit of the audio apparatus can also leverage information of the displacement and movement of the apparatus, such as velocity and acceleration in a Cartesian coordinate system to provide a more accurate mapping between the captured spatial and directional audio to the global space. More specifically, as opposed to the device capturing where the speaker or audio source is only relative to the case itself (i.e., local coordinate system), a device that uses an accelerometer or a series of them can ideally also allow the device to determine where the audio source occurred in the large global space and coordinate system even when the device is moved or constantly moving while performing audio capture.

As previously mentioned with reference to the user interface, some examples of the audio apparatus include audio-out devices such as internal speakers or an audio-out port embedded in the device. In addition to serving the functionality of announcing the state and system notifications of the device, internal speakers and audio-out ports can also be used to broadcast previously recorded audio as well as other pre-loaded, downloaded, or streamed music. Audio apparatus according to the present technology may include multiple speakers in the stand of the device (see FIG. 5, for example), as spaced along the periphery of the stand (along the periphery of the bottom of case 220, for example). The speakers will be able to broadcast spatial or directional audio, e.g., audio previously recorded by the apparatus or pre-recorded audio uploaded or shared from an external device. The provision of an audio-out port will allow users to plug in headphones to listen to the otherwise broadcasted audio. When plugged into a headphone, the user can play audio clips that were previously recorded using the audio apparatus, as well as other pre-loaded, downloaded, or streamed music.

In examples of the audio apparatus having on-device microprocessors, according to the present technology, the microprocessors are used for post processing the audio audio after the beamforming algorithm has been executed to enhance the audio. In contrast to microprocessors of a processing unit for processing the raw audio input into directional and spatial audio, these on-device microprocessors can be used to provide additional auxiliary functionalities such as speech recognition, speech-to-text transcription, and speaker labeling. The on-device microprocessors may also be configured with more advanced forms of Natural Language Processing algorithms such as Large Language Models, may be configured to perform sentiment analysis, and may constitute a virtual assistant. In some examples, the processing unit of the audio apparatus has microprocessors configured to perform speech-to-text transcription and speaker identification, which will allow the apparatus to transmit both the processed directional and spatial audio, as well as the text transcriptions from each of the distinctive speakers in real-time. In some examples in which the on-device microprocessors are configured for real-time speaker sentiment analysis, the categorization of the sentiments is reflected synchronously through the user interface by such means as changes in LED colors or dynamic and adaptive visualizations on a touch display. Additionally, results of the sentiment analysis can be transmitted alongside the directional and spatial audio information in real-time to external outlets.

In some examples of audio apparatus according to the present technology, the processing unit may include custom circuitry comprising an amplifier or denoising circuitry for amplifying or denoising the signals from the microphone(s) of the microphone-equipped devices. These circuitries can be located either in the stand or in an external case externally linked and connected to the stand. Although the beamforming algorithm could be used to denoise the raw captured audio input, additional denoising circuitry can further improve this effect. While not necessary, additional circuitry that is used to amplify or denoise the received audio input can help to enhance the quality and clarify of the captured directional and spatial audio. Some examples of audio apparatus according to the present technology include a customized amplification circuit that will serve to augment the raw audio inputs captured directly from the microphones of the microphone-equipped devices. The amplification circuit preferably accounts for the specific design and spatial configuration of the acoustical channels (e.g., 224 or 324), especially when they are constituted by a transparent acoustical material such as an open cell foam, when pre-processing the raw audio inputs. In other examples, on-device denoising circuitry is used to filter out ambient sounds from the captured audio inputs. By, for example, thresholding the raw audio before inputting them to the beamforming algorithm to further process, the denoising circuitry can further enhance the clarity and quality of the processed directional and spatial audio.

Finally, although the present technology has been described above in detail with respect to various embodiments and examples thereof, the present technology may be embodied in many other different forms. Thus, the present invention should not be construed as being limited to the embodiments and their examples described above. Rather, these embodiments and examples were described so that this disclosure is thorough, complete, and fully conveys the present invention to those skilled in the art. Thus, various alternatives or changes to and modifications of the disclosed embodiments are seen to be within the true spirit and scope of the present invention as defined by the appended claims.

What is claimed is:

1. Audio apparatus for capturing ambient sound and producing an enhanced audio signal from the captured sound, comprising:
a plurality of discrete self-contained electronic devices each including a receiver, a microphone or microphone array, and a casing housing the receiver and the microphone or microphone array, wherein the electronic devices each or collectively have an audio functionality apart from the apparatus; and
a stand discrete from the electronic devices and having means for temporarily holding the electronic devices in respective static positions at which the microphone or microphone array of each of the electronic devices is acoustically exposed to the ambient environment outside the stand, whereby the microphone or microphone array of each of the electronic devices will capture ambient sounds when held in said respective static positions and convert the sound to streams of audio signals, and
wherein the audio apparatus includes a processing unit operatively connected to the microphone or microphone array of each of the electronic devices so as to receive as input streams of audio signals from the microphones or microphone arrays of the electronic devices, the processing unit storing information indicative of distance between and orientations of the microphones or microphone arrays of the electronic devices in said respective static positions, and the processing unit being configured to process sound captured by each said microphone or microphone array based on said information, and
the audio apparatus includes a transmitter or at least one speaker operatively connected to the processing unit to transmit enhanced audio resulting from the processing of the streams of audio signals based on said information indicative of the distance between and orientations of the microphones or microphone arrays of the electronic devices.

2. The audio apparatus as claimed in claim 1, wherein the electronic devices are ear-worn audio devices.

3. The audio apparatus as claimed in claim 2, wherein the stand is a case having a base and a cover attached to the base so as to be openable and closeable relative to the base, and the means for temporarily holding comprises cavities in the case having shapes complementary to contours of the casings of the ear-worn audio devices, respectively.

4. The audio apparatus as claimed in claim 3, wherein the case has acoustical channels extending therethrough to the microphones of the ear-worn audio devices, respectively, the acoustical channels acoustically exposing the microphones of the ear-worn audio devices to the ambient environment outside the case.

5. The audio apparatus as claimed in claim 3, wherein the case includes a sensor operative to sense whether the cover is open or closed.

6. The audio apparatus as claimed in claim 1, wherein the electronic devices are smart phones.

7. The audio apparatus as claimed in claim 6, wherein the stand is a platform, and the means for holding comprises cavities in the platform having shapes complementary to contours of the casings of the smart phones, respectively.

8. The audio apparatus as claimed in claim 1, wherein the means for temporarily holding comprises ferromagnetic elements for attracting the electronic devices to said static positions, respectively.

9. The audio apparatus as claimed in claim 1, comprising sensors operative to sense whether the electronic devices are in said static positions, respectively.

10. Audio apparatus for capturing ambient sound and producing an enhanced audio signal from the captured sound, comprising:
a plurality of discrete microphone-equipped devices each having a receiver, a microphone or microphone array and a speaker, and a casing housing the receiver and/or transmitter, speaker and microphone or microphone array, wherein the microphone-equipped devices each or collectively have an audio functionality apart from the apparatus;
a stand discrete from the microphone-equipped devices and having means for temporarily holding the microphone-equipped devices in respective static positions at which the microphone or microphone array of each of the microphone-equipped devices is acoustically exposed to the ambient environment outside the stand, whereby the microphone or microphone array of each of the microphone-equipped devices will capture ambient sounds when held in said respective static positions; and
a processing unit comprising a processor operatively connected to each of the microphone-equipped devices, and non-transitory computer-readable media (CRM) storing operating instructions and information indicative of distance between and orientations of the microphones or microphone arrays of the microphone-equipped devices in said static positions, the processor being configured to execute the operating instructions to:
control the microphone-equipped devices to capture raw audio and convert the raw audio to streams of audio signals,
process the streams of audio signals based on the information indicative of the distance between and orientations of the microphone-equipped devices, and transmit a result of the processed streams of audio signals.

11. The audio apparatus as claimed in claim 10, wherein the microphone-equipped devices are ear-worn audio devices or smartphones.

12. The audio apparatus as claimed in claim 11, wherein the means for temporarily holding comprises cavities in the stand having shapes complementary to contours of the casings of the ear-worn audio devices or smartphones, respectively.

13. The audio apparatus as claimed in claim 10, comprising sensors operative to sense whether the microphone-equipped devices are in said static positions, respectively, the sensors being operatively connected to the processing unit such that the processing unit controls the microphone-equipped devices to capture audio when the sensors confirm the presence of the microphone-equipped devices in their static positions.

14. The audio apparatus as claimed in claim 10, wherein the processor is disposed on board the stand or as part of an external device of the audio apparatus discrete from the stand and the microphone-equipped devices.

15. The audio apparatus as claimed in claim 14, wherein the processing unit is also configured to execute the operating instructions to:
process the streams of audio signals using a beam forming algorithm.

16. The audio apparatus as claimed in claim 14, wherein the processing unit is also configured to execute the operating instructions to:
time synchronize the streams of audio signals.

17. A method of producing high-fidelity audio signals by leveraging electronic devices each including a receiver, a microphone or microphone array, and a casing housing the receiver and the microphone or microphone array, the method comprising:
taking the electronic devices and temporarily fixing them to a stand in static positions as spaced apart from each;
capturing sound from the ambient environment outside the stand using the microphones or microphone arrays of the electronic devices while the electronic devices are fixed to the stand in said static positions, and converting the sounds to respective streams of audio signals;
digitally processing the streams of audio signals based on information including distance between and orientations of the electronic devices in said static positions; and
transmitting the digitally processed audio signals.

18. The method as claimed in claim 17, wherein the processing is carried out on board the stand or as part of an external device discrete from the stand and the electronic devices.

19. The method as claimed in claim 17, wherein the raw streams of audio signals are processed using a beam forming algorithm.

20. The method as claimed in claim 17, wherein the processing comprises time synchronizing the streams of audio signals.
